(19) United States
(12) Patent Application Publication
(10) Pub. No.: US 2011/0140048 A1
(43) Pub. Date: Jun. 16, 2011

(54) LOW-VOC SILOXANE COMPOSITIONS

(76) Inventor: El Sayed Arafat, Leonardtown, MD (US)

(21) Appl. No.: 13/009,281

(22) Filed: Jan. 19, 2011

Related U.S. Application Data
(63) Continuation-in-part of application No. 12/639,476, filed on Dec. 16, 2009, now Pat. No. 7,897,558.

(51) Int. Cl. C09K 3/00

(52) U.S. Cl. 252/364

(57) ABSTRACT

This invention relates to non-volatile siloxane compositions having low VOC, a flash point above 140° F., and a vapor pressure of less than seven millimeters of mercury (7 mm Hg). The non-volatile siloxane compositions consist essentially of specific amounts of alkylated cyclosiloxane have 5 or 6 repeating siloxane units, an alkylated cyclosiloxane having 3 or 4 repeating siloxane units, at least one alkylene glycol alkyl ether acetate and monohydric aliphatic alcohols.

### RELATED U.S. APPLICATION

This application is a continuation-in-part of co-pending application Ser. No. 12/639,476, filed on Dec. 16, 2009.

### GOVERNMENT INTEREST

The invention described herein may be manufactured, licensed, and used by or for the U.S. Government.

### FIELD OF THE INVENTION

This invention relates to solvent compositions and to the method of using said solvents which comprises a unique combination of two or more different alkylated cyclic siloxanes, alcohols and glycol-ether acetates characterized as low-volatile organic or non-volatile organic compositions with flash points above 140° F. and vapor pressures of less than seven millimeters of mercury (7 mm Hg).

### BACKGROUND OF THE INVENTION

Cold solvent cleaning of aircraft components is performed at organizational, intermediate and depot levels and usually takes the form of either spray sinks or batch-loaded dip tanks. The solvent used and widely approved is MIL-PRF-680 Type II, which has a VOC (Volatile Organic Compound) content of more than 750 g/l. VOCs are released during cleaning operations, contributing to the formation of ground-level ozone (photochemical smog) and can damage lung tissue, cause respiratory illness and damage vegetation. Solvent emissions are regulated regionally as well as by state and national regulations. New environmental regulations are making it increasingly more difficult to use solvents containing VOCs in weapon cleaning operations. Air Pollution Control Districts in California implement the most stringent requirements, usually stated in terms of VOC content (Rule 1171). The South Coast Air Quality Management District (SCAQMD) has imposed restrictions limiting the use of solvents with VOC content to 25 g/L for immersion cleaning processes or limiting equipment to airtight cleaning systems. To meet the new environmental regulations, this invention discloses the method of preparation and the properties of low-VOC and HAP-free solvent, which is called Navsolve.

Solvent cleaners are known for their cleaning ability, quick drying, metal compatibility, and low surface tension to facilitate penetration. Unfortunately, some of these solvents are also known for the air pollution they cause (as volatile organic compounds or VOC₈), toxicity, flammability, and incompatibility with plastics. The use of volatile organic compounds (“VOC”) solvents has been discouraged due to their deleterious effect on the environment. Regulations have been promulgated to accelerate the phase-out of environmentally destructive solvents. The Environmental Protection Agency (“EPA”) promulgates rules and regulations regarding environmental concerns such as VOCs. EPA has defined a VOC to include any volatile compound of carbon which participates in atmospheric photochemical reactivity. Thus, there is a need to reduce the use of conventional VOC solvents. It is apparent that a need exists for a solvent system which has little or no VOC content. The old specification P-D-680 solvent, commonly called Stoddard solvent or mineral spirits, contains petroleum fractions that are complex mixtures of mostly aliphatic hydrocarbons, but may contain some aromatics and olefinics. As such, P-D-680 contains hazardous air pollutants (HAPs) and VOCs, and causes health and environmental concerns. The revision to MIL-PRF-680 eliminated the HAPs but MIL-PRF-680 still covers a petroleum-based solvent, containing the same amount of VOCs as P-D-680. Since P-D-680 was first written in 1963, these solvents have been specified for general cleaning to remove oil and grease from aircraft and engine components and from ground support equipment.

There are several alternatives to the P-D-680/MIL-PRF-680 solvents: water-based, semi-aqueous, and solvent-based cleaners. Water-based cleaners contain detergents to remove grease and oil and may be used hot and/or with various forms of agitation (spray or ultrasonic). Disadvantages include flash rusting, embrittlement of high strength steel and poor cleaning efficiency. Semi-aqueous cleaning processes incorporate not only detergents, but also solvents to improve effectiveness. Some products contain solvents emulsified in water while others contain water-rinsable solvents. A significant disadvantage to semi-aqueous cleaners is their susceptibility to separation. Solvent-based cleaners, however, continue to be used in effective, low cost cleaning processes. In order to retain the capability of solvent cleaning, a new type of solvent was needed to meet the HAP and VOC requirements.

Under Title III of the 1990 Clean Air Act (CAA) amendments, the U.S. Environmental Protection Agency (EPA) has established emissions standards for categories and sub-categories of sources that emit or have the potential to emit listed HAPs. In addition, Under the proposed rule, MIL-PRF-680 will no longer be allowed in solvent degreasing operations in the SCAQMD. If a substitute material or process is not authorized, the Aircraft Intermediate Maintenance Detachment (AIMD) at Lemoore and other maintenance facilities will not be able to perform specific maintenance requirements in accordance with NVAIR technical manuals. Since MIL-PRF-680 is the only material authorized by the applicable maintenance manuals to clean flight critical parts, an approved alternative for MIL-PRF-680 was necessary to meet the new environmental regulations.

To meet the new regulations, NAVAIR's Aircraft Materials Laboratory at Patuxent River, Md., recently tested several commercial products. As a result, a new specification MIL-PRF-32295A entitled “Cleaner, Non-Aqueous, Low-VOC, HAP-Free,” was developed to provide environmentally friendly cleaners to the Department of Defense (DoD) services. The new specification requires that a solvent must be free of HAPs, must contain no more than 25 grams per liter of VOCs, must be effective on grease and oil, must not contain ozone-depleting substances (non-ODS), must be non-toxic, must be compatible with metals and non-metals, and must be safe to use. In addition, the Aerospace National Emission Standards for Hazardous Air Pollutants (NESHAP) states that immersion-cleaning solvents must have vapor pressures less than 7 mm Hg, and wipe cleaning solvents must have vapor pressures less than 45 mm Hg. MIL-PRF-32295A classifies as a low vapor pressure solvent (less than 7 mm Hg) as Type I and as a moderate vapor pressure solvent (less than 45 mm Hg) as Type II. This invention will meet the requirements of MIL-PRF-32295A Type II specification. The siloxane solvents of this invention qualify to be used to clean weapon systems across DoD maintenance facilities as alternatives to MIL-PRF-680.

### SUMMARY OF THE INVENTION

The present invention relates to cyclic siloxane compositions characterized as low-volatile organic or non-volatile organic solvents. The non-volatile (non-VOC) organic solvents consist essentially of a combination of at least one or more alkylated cyclosiloxanes having 5 or 6 repeating siloxane units or silicone atoms and at least one alkylated cyclosiloxane having 3 or 4 repeating siloxane units or silicone atoms, at least one alkylene glycol alkyl-ether acetate and an aliphatic alcohol and particularly lower monohydric alcohols having of up to eight carbons. These non-volatile organic cyclosiloxane solvents are specifically characterized as having a flash point above 140° F. and a vapor pressures of less than 7.0 millimeters of mercury (mm·Hg.).

### DETAILED DESCRIPTION OF THE INVENTION

The present invention relates to alkylated cyclosiloxane compositions consisting essentially of low-volatile (low-VOC) or non-volatile (non-VOC) compounds. These cyclosiloxane compositions are characterized further as having flash points above 140° F., and have vapor pressures of less than 7.0 millimeters of mercury (7 mmHg.).

The cyclosiloxane compositions are particularly useful as low or non-volatile (non-VOC) solvents consisting essentially of about 50 to 75 parts and more particularly 60 to 70 or 65 parts by weight of a combination of siloxanes wherein at least one of said alkylated cyclosiloxanes have 5 or 6 repeating siloxane units or silicone atoms wherein said alkylation or alkyl substituents of at least one of the siloxane units has from 1 to 4 linear or branched carbon atoms including, for example, methyl, ethyl, propyl, isopropyl, butyl, or isobutyl carbons, and from about 20 to 40 and more particularly 25 to 35 or 32 parts by weight of at least one alkylated cyclosiloxane having 3 or 4 repeating siloxane units or silicone atoms wherein said alkylation or alkyl substituents of at least one of the siloxane units has from 1 to 4 linear or branched carbon atoms including, for example, methyl, ethyl, propyl, isopropyl, butyl, isobutyl carbons, and from about 1.0 to 4.0 and more particularly 1.0 to 3.0 parts by weight of at least one alkylene glycol alkyl-ether acetate wherein said alkyl substituent has 1 to 4 branched or linear carbon atoms such as methyl, ethyl, propyl or butyl carbons, and from about 0.1 to 2.0 or 0.8 parts by weight of a monohydric-alcohol having up to 8 carbons and preferably 3 to 6 carbons. The alkylation of the cyclosiloxanes can be alkylated from alkyl compounds that are branched or linear and are either all the same or different alkyl compounds.

Typical examples of the cyclosiloxanes having 3 or 4 repeating siloxane units, and cyclosiloxanes having 5 or 6 siloxane units include, for example, tetramethylcyclotetrasiloxane, 1,3,5,7-tetraethylcyclotetrasiloxane, 1,3,5,7,9-pentamethylcyclopentasiloxane, 1,3,5,7,9-pentaethylcyclopentasiloxane, octamethyl cyclotetrasiloxane, decamethyl pentacyclosiloxane, tetramethylcyclotrisiloxane, hexamethyl cyclohexasiloxane and dimethyl cyclotrisiloxane. Particularly suitable is a mixture of octamethylcyclotetrasiloxane and decamethylcyclopentasiloxane with a dipropylene or diethylene glycol monoalkyl ether-acetate and a monohydric aliphatic alcohol of 1 to 8 carbons such as amyl alcohol. The alkylene glycol alkyl-ether acetates particularly include the monoalkyl ether-acetates of dipropylene glycol, diethylene glycol, triethylene glycol, tetraethylene glycol, preferably glycols having 6 to 8 carbons and the lower molecular weight polyethylene or polypropylene glycol alkyl ether acetates wherein the alkyl group of the ether acetate has from 1 to 4 branched or linear carbon atoms.

The following examples illustrate the cyclosiloxane solvent compositions of this invention.

### EXAMPLE I

| | Parts by Wt. |
|---|---|
| Decamethylcyclopentasiloxane | 50-75 |
| Octamethylcyclotetrasiloxane | 20-40 |
| Dipropylene glycol methyl ether acetate | 1.0-4.0 |
| Aliphatic monohydric alcohol of 1 to 8 carbons | 0.1-2.0 |

### EXAMPLE II

| | Parts by Wt. |
|---|---|
| Decaalkylcyclopentasiloxane | 65.00 |
| Octaethylcyclotetrasiloxane | 32.00 |
| Dipropylene glycol methyl ether acetate | 2.20 |
| Amyl alcohol | 0.80 |

### EXAMPLE III

| | Parts by Wt. |
|---|---|
| Decaethylcyclopentasiloxane | 60-70 |
| Octamethylcyclotetrasiloxane | 25-35 |
| Alkylene glycol monoalkyl ether acetate | 1.0-3.0 |
| Aliphatic monohydric alcohol | 0.1-2.0 |

### Properties of the Cyclosiloxane Compositions of the Invention

### Cleaning Efficiency

The cleaning efficiency test for the alkylated cyclosiloxane solvents (Navsolve cleaner) of this invention was conducted in accordance with MIL-PRF-32295A specification (test Method 4.5.9) as described below.

Preparation of test specimens. Stainless steel coupons 1 by 2 by 0.05 inches (25 by 50 by 1.3 mm) was polished with 240 grit aluminum oxide abrasive paper or cloth and solvent wiped with isopropyl alcohol. Coupons were weighed (weight=W1), coated on one side with 20-25 mg of soil, then reweighed (weight=W2). Soils tested were as follows:

a. MIL-G-21164 (grease, molybdenum disulfide, for low and high temp)

b. MIL-PRF-83282 (hydraulic fluid, fire resistant, synthetic hydrocarbon)

c. MIL-PRF-10924 (grease, automotive and artillery)

Test procedure. Fresh solvent was used for each soil tested. Each test coupon was cyclically immersed and withdrawn from a 150-ml beaker containing 100 ml of the cleaner at a rate of 20 cycles per minute for 5 minutes. Each coupon shall then be dried for 10 minutes at 140±4° F. (60±2° C.), cooled to room temperature, and reweighed (weight=W3). Cleaning efficiency for the cleaner was calculated as follows for each coupon:

% Cleaning efficiency=(W2−W3)/(W2−W1)×100

The test result for each soil shall be the average of three coupon cleaning efficiencies.

TABLE 1
Cleaning Efficiency Test Results for Navsolve
in Accordance with MIL-PRF-32295A

| | Requirements | |
|---|---|---|
| Soil/Product | MIL-PRF-32295A Type II | Navsolve |
| MIL-G-21164 | 70% | 71% |
| MIL-PRF-10924 | 85% | 91% |
| MIL-PRF-83282 | 95% | 99% |

### Volatile Organic Compounds (VOC) Analysis

The VOC content for Navsolve cleaner was measured in accordance with MIL-PRF-32295A Specification (SCAQMD Method 313-91). The South Coast Air Quality Management District, Diamond Bar, Calif. performed the VOC analysis for Navsolve cleaner and found as 15.7 g/l; the VOC content for MIL-PRF-680 is more than 750 g/l. In addition, Navsolve has met the requirements of the Clean Air Solvent Certification (CAS). The advantages of the CAS products include the following properties: low-VOC, HAP-free, lowVapor pressure, ODC-free, and free of Global Warming Compounds.

TABLE 2
Test Results of Navsolve to Clean Air Solvent
Certification Requirements (SCAQMD)

| Properties | ACS Certification Limits | Navsolve |
|---|---|---|
| VOHAPS, ODC, GWC, | <0.1 | <0.1 |
| wt % | | |
| MIR | <1.9 | <1.9 |
| VOC g/L | <25 | 15.7 |
| VP mmHg | <5 | 3.0 |
| Water, wt % | No limit | 0.2 |
| Density, g/ml | No limit | 0.95 |

VOHAPS: Volatile Organic Hazardous Air Pollutants
ODC: Ozone Depleting Compounds
GWC: Global Warming Compounds
MIR: Maximum Incremental Reactivity
VOCs: Volatile Organic Compounds
VP: Vapor Pressure

### Total Immersion Corrosion Test

The total immersion corrosion test for Navsolve cleaner was conducted in accordance with the requirements of MIL-PRF-32295A specification (ASTM F483) and gave the following results:

TABLE 3
The Total Immersion Corrosion Test Results for Navsolve

| | MIL-PRF-32295A | Navsolve |
|---|---|---|
| Metal/Product | mg/cm2/day | mg/cm2/day |
| Aluminum (SAE-AMS-QQ- | 0.04 | 0.0001 |
| A-250/4 | | |
| Aluminum (SAE-AMS-QQ- | 0.04 | 0.0001 |
| A-250/12) | | |
| Titanium (SAE-AMS4911) | 0.04 | 0.0001 |
| Magnesium (SAE-AMS-M- | 0.20 | 0.0007 |
| 3171) | | |
| Steel (SAE-AMS5040) | 0.04 | 0.0003 |

### Sandwich Corrosion Test

The sandwich corrosion test for the cyclosiloxane solvents (Navsolve cleaner) was conducted in accordance with MIL-PRF-32295A specification requirements (ASTM F 1110); the product met the requirements successfully. The following aluminum alloys were used in conducting the sandwich corrosion test:

Aluminum SAE 250/4

Aluminum SAE 250/5

Aluminum SAE 250/12

Aluminum SAE 250/13

### Flash Point

The flash point of flammable liquid is the lowest temperature at which it can form an ignitable mixture in air. The flash point for Navsolve cleaner was measured in accordance with MIL-PRF-32295A specification (ASTM D-56) and found as 140° F. to 145° F. To avoid the flammability problems, the flash point for the solvent must be 140° F. or higher. The flash point property is essential for solvent cleaner selection to ensure worker safety and health protection.

### Hydrogen Embrittlement Test

The hydrogen Embrittlement test was conducted in accordance with MIL-PRF-32295A specification (ASTM F519); using cadmium-plated AIS14340, type la specimens. Each specimen was stressed by applying a load equivalent to 45 percent of notch fracture strength. The notch was immersed in the cleaner for the duration of the test (150 hours). Navsolve cleaner has met the requirements successfully.

### Advantages and New Features

To meet the new environmental regulations, it is essential to identify and validate effective, safe, and environmentally friendly products for cleaning applications. The advantages of Navsolve cleaner are listed below:

Low VOC contents (16.0 g/L)

Free of Hazard Air Pollution (HAP-free)

Acceptable flash point (140E-145F)

Compatible with metals and non-metals

Non-corrosive

Non-Toxic

Cleaning efficiency is equivalent to the high VOC control (MIL-PRF-680).

TABLE 4
Properties and Test Methods, MIL-PRF-32295A (NAVSOLVE)

| PROPERTY | REQUIREMENT | | | TEST METHOD | RESULT |
|---|---|---|---|---|---|
| VOC content | Type 1, 25 | Type II, 25 | Type III | SCAQMD | 15.7 |
| grams/liter (maximum) | | | No Limit | Method 313 | |
| Apparent specific | No change from qualification sample | | | ASTM D891 | 0.960 Informational |
| gravity, 60/60° F. | | | | | |
| Vapor pressure, mm | Type 1 | Type II | Type III | ASTM D2879 | 2 mm Hg |
| Hg at 20° C. (maximum) | 7 | 45 | No Limit | | Conforms |
| | | | | | (Types I & II) |

| | | | |
|---|---|---|---|
| Flash point, ° F. (° C.) | 140 (60) | ASTM D56 | No flash to |
| (minimum) | | | 141° F. Conforms |
| Nonvolatile residue, | 5 | ASTM D1353 | 3 mg/100 mls |
| mg/100 ml, (maximum) | | | Conforms |
| Acidity | 0.02* | ASTM D1613 | Acidity as Acetic Acid, |
| | | | wgt. % = <0.02 |
| | | | Conforms |
| Odor | No-offensive, low intensity, non-residual | ASTM D1296 | Non-offensive, |
| | | and 4.5 10 | low intensity, |
| | | | non-residual |
| | | | Conforms |
| Miscibility with water | Immiscible | 4.5.1 | Immiscible |
| | | | Conforms |
| Drying time, minutes | 50 | 4.5.2 | Less than 50 min. |
| (maximum) | | | Conforms |
| Low temperature | No freezing and no separation | 4.5.3 | No freezing/separation |
| stability | | | Conforms |
| Sandwich corrosion | Rating of 1 | ASTM F1110 | Ratings = 1, maximum |
| (maximum) | | | Conforms |
| Immersion corrosion, | 0.04 | ASTM F483 | QQ-A-250/4: <0.04 |
| mg/cm²/day (maximum) | 0.20 | and 4.5.4 | QQ-A-250/*12: <0.04 |
| Aluminum, Titanium, | | | AMS-4011: <0.04 |
| Steel Magnesium | | | AMS-5040: <0.04 |
| | | | AMS-4377: <0.20 |
| | | | Conforms |
| Cadmium corrosion | 0.20 | ASTM F1111 | 0.02 mg/cm²/day |
| test, mg/cm²/day | | | Conforms |
| (maximum) | | | |
| Copper corrosion | 1b | ASTM D130 | 1b Conforms |
| rating (maximum) | | and 4.5.5 | |
| Effect on unpainted | No streaks or stains | ASTM F485 | Conforms |
| surfaces | | | |
| Hydrogen embrittlement | No failures in less than 150 hours when | ASTM F519 | Type 1a, |
| | specimens are loaded to 45 percent of | and 4.5.6 | cadmium plated: |
| | fracture strength and immersed in cleaner | | No failures |
| | | | within 150 hours |
| | | | Conforms |

TABLE 5
Properties and Test Methods - Continued

| PROPERTY | REQUIREMENT | | TEST METHOD | RESULT |
|---|---|---|---|---|
| Titanium stress corrosion | No cracking | | ASTM F945 | AMS 4911/AMS 4918 |
| (examined with 500X | | | Method A | No cracking |
| magnification) | | | | Conforms |
| Effect on painted surfaces | No streaks, fading, blisters, or | | ASTM F502 | No effect |
| | discoloration No softening >1 | | | Conforms |
| | pencil hardness | | | |
| Effect on plastics | No crazing | | ASTM F484 | Type A: No crazing |
| Acrylic, | No crazing after 2 hrs at 2000 psi | | | Conforms |
| Type A & C Polycarbonate | | | | Type C: No crazing |
| AMS-P-83310 | | | | Conforms |
| | | | | 83310: No crazing |
| | | | | Conforms |
| Effect on polyimide wire | No more insulation cracking than | | D3755 | No dielectric break- |
| | with distilled water and no | | | down or leakage. |
| | subsequent dielectric breakdown | | | Conforms |
| | or leakage | | | |
| Effect on sealant | No change in Shore A hardness | | 4.5.8 | No change in Shore A |
| | greater than ±5 units | | | hardness greater |
| | | | | than ±5 units |
| | | | | Conforms |
| Cleaning efficiency on | Type I | Type II | 4.5.9 | MIL-PRF-83282: 99% |
| MIL-PRF-83282 soil | No less | No less | | |
| | than 85% | than 95% | | |
| MIL-G-21164 soil | No less | No less | | MIL-G-21164: 71% |
| | than 60% | than 70% | | |
| MIL-PRF-10924 grease | No less | No less | | MIL-PRF-10924; 91% |
| | than 75% | than 75% | | Conforms |
| | | | | (Type I & Type II) |

TABLE 6
Properties and Test Methods MIL-PRF-32295A

| PROPERTY | REQUIREMENT | | | TEST METHOD |
|---|---|---|---|---|
| Titanium stress corrosion | No cracking | | | ASTM F945 |
| (examined with 500X | | | | Method A |
| magnification) | | | | |
| Effect on painted | No streaks, facing, blisters, or discoloration | | | ASTM F502 |
| surfaces | No softening >1 pencil hardness | | | |
| Effect on plastics | No crazing No crazing after 2 hours at 2000 psi | | | ASTM F484 |
| Acrylic, type A&C | | | | |
| Polycarbonate, AMS-P- | | | | |
| 83310 | | | | |
| Effect on polyimide wire | No more insulation cracking than with distilled | | | 4.5.7 |
| | water and no subsequent dielectric breakdown | | | |
| | or leakage | | | |
| Effect on sealant | No change in Shore A hardness greater | | | 4.5.8 |
| | than ±5 units | | | |
| Cleaning efficiency on | Type 1 | Type 1I | Type 1II | 4.5.9 |
| MIL-PRF-83282 soil | ≧85% | ≧95% | ≧85% | |
| Mil-G-21164 soil | ≧60% | ≧70% | ≧60% | |
| Mil-PRF-10924 soil | ≧75% | ≧85% | ≧75% | |

Immersion Corrosion. The immersion corrosion test was conducted in accordance with ASTM F483 (using 7 day duration) on test panels constructed on the following materials. The results are shown in TABLE 7.

TABLE 7

| | WEIGHT CHANGE | |
|---|---|---|
| | (mg/cm²/day) | |
| | MAX | |
| TEST PANEL | ALLOWABLE | RESULTS |
| Aluminum alloy 2024 (T3 temper), | 0.04 | 0.01 |
| conforming to SAE-AMS-QQ-A-250-4 | | |
| Aluminum alloy 7075 (T6 temper), | 0.04 | 0.01 |
| conforming to SAE-AMS-QQ-A-250-12 | | |
| Titanium alloy (6A1-4V) conforming | 0.04 | 0.01 |
| to SAE-AMS4911 | | |
| Carbon steel (1020), conforming | 0.04 | 0.01 |
| to SAE-AMS5040 | | |
| Magnesium alloy (AZ31B-H24), | 0.20 | 0.01 |
| conforming to SAE-AMS4377, chrome | | |
| pickled to SAE-AMS-M-3171, type V1 | | |

While various embodiments of the invention have been disclosed, the specific composition and methods described herein are not intended to limit the scope of the invention.

What is claimed is:

1. A non-volatile siloxane composition having a low VOC, a flash point above 140° F., and a vapor pressure of less than 7.00 millimeters of mercury (7 mm Hg) consisting essentially of about 50 to 75 parts by weight of at least one alkylated cyclosiloxane having 5 or 6 repeating siloxane units, about 20 to 40 parts by weight of at least one alkylated cyclosiloxane having 3 or 4 repeating siloxane units, about 1.0 to 4.0 parts by weight of at least one alkylene glycol alkyl-ether acetate, and from about 0.1 to 2.0 parts by weight of a monohydric aliphatic alcohol.

2. The siloxane composition of claim 1 wherein the alkyl group of the alkylene glycol alkyl-ether acetate has 1-4 carbon atoms.

3. The siloxane composition of claim 1 wherein the 50 to 75 parts of the cyclosiloxane has 5 repeating siloxane units.

4. The siloxane composition of claim 1 wherein the 20 to 40 parts of the clyclosiloxane has 4 repeating siloxane units.

5. The siloxane composition of claim 1 wherein the alkyl substituent of at least one of said cyclosiloxane units has 1 or 2 carbons.

6. The siloxane composition of claim 1 wherein the alkylated substituent of the siloxanes are methyl substituents.

7. The siloxane composition of claim 2 wherein the glycol alkyl-ether is dipropylene glycol methyl-ether acetate.

8. A non-volatile siloxane composition having a low VOC, a flash point above 140° F., and a vapor pressure of less than 7.0 millimeters of mercury (7 mm Hg) consisting essentially of from about 60 to 70 parts by weight of at least one alkylated clyclosiloxane having 5 repeating siloxane units wherein the alkyl substituent of at least one of the siloxane units has 1 to 4 carbon atoms, about 25 to 35 parts by weight of at least one alkylated cyclosiloxane having 4 repeating siloxane units wherein the alkyl of at least one substituent of the siloxane units has 1 to 4 carbon atoms and about 1.0 to 3.0 parts by weight of at least one alkylene glycol alkyl-ether acetate wherein said alkyl substituents have 1 to 4 carbon atoms and from about 0.1 to 2.0 parts by weight of a monohydric aliphatic alcohol having 1 to 8 carbons.

9. The non-volatile siloxane composition of claim 8 wherein said cyclosiloxane having 5 repeating siloxane units is decamethylcyclopentasiloxane.

10. The non-volatile siloxane composition of claim 8 wherein said cyclosiloxane having 4 repeating siloxane units is octamethylcyclotetrasiloxane.

11. The non-volatile siloxane composition of claim 8 wherein said alkylene glycol alkyl-ether acetate is dipropylene glycol methyl-ether acetate.

12. The non-volatile siloxane composition of claim 8 wherein the alkylated substituents of said siloxanes are derived from alkyl compounds that are either the same or different and have branched or linear carbon atoms.

13. A non-volatile siloxane composition having a low VOC, a flash point above 140° F., and a vapor pressure of less than seven millimeters of mercury (7 mm Hg.) consisting essentially of about 65 parts by weight of at least one alkylated cyclosiloxane having 5 or 6 repeating siloxane units wherein the alkylated substituent of at least one of the siloxane units has 1 to 4 carbon atoms, about 32 parts by weight of at least one alkylated cyclosiloxane having 3 or 4 repeating siloxane units wherein the alkylated substituent of at least one of the siloxane units has 1 to 4 carbon atoms, about 1.0 to 4.0 parts by weight of at least one alkylene glycol alkyl-ether acetate wherein said alkyl group has 1.0 to 4.0 carbon atoms and at least one monohydric aliphatic alcohol having 1 to 8 carbons.

14. The siloxane composition of claim 13 wherein the alkyl group of the glycol ether acetate has 1 or 2 carbon atoms.

15. The siloxane composition of claim 13 wherein the 65 parts of the cyclosiloxane has 5 repeating siloxane units.

16. The siloxane composition of claim 15 wherein the 32 parts of the cyclosiloxane has 4 repeating siloxane units.

17. The siloxane composition of claim 16 wherein the alkyl substituents of said siloxanes have 1 or 2 carbon atoms.

18. The siloxane composition claim 16 wherein the alkylene glycol alkyl-ether acetate is dipropylene glycol methyl-ether acetate.

19. The non-volatile siloxane composition of claim 13 wherein the alkylated substituents are derived from alkyl compounds that are either the same or different and are branched or linear carbon atoms.

20. The non-volatile siloxane composition of claim 19 wherein the alkylated substituent has 3 or 4 branched or linear carbon atoms.
